(19) United States
(12) Patent Application Publication
(10) Pub. No.: US 2024/0407452 A1
(43) Pub. Date: Dec. 12, 2024

(54) ATOMIZATION SYSTEM INCLUDING ATOMIZING UNIT AND BATTERY UNIT

(71) Applicant: PACIFIC SMOKE INTERNATIONAL INC., MARKHAM (CA)

(72) Inventors: Richard Liu, Markham (CA); Xie Huaiyan, Shenzhen (CN)

(21) Appl. No.: 18/738,274

(22) Filed: Jun. 10, 2024

(30) Foreign Application Priority Data
Jun. 8, 2023 (CN) 202321465592.5
Mar. 28, 2024 (CN) 202420629678.5

(51) Int. Cl. A24F 40/485; A24F 40/46; A24F 40/57; H01M 50/247; H01M 50/296; H02J 7/00

(52) U.S. Cl. CPC A24F 40/485; A24F 40/46; A24F 40/57; H01M 50/247; H01M 50/296; H01M 2220/30

(57) ABSTRACT

An atomizing unit and a battery unit for an atomization system is disclosed. In some embodiments, the atomizing unit and the battery unit have interfaces configured to couple in at least a high-airflow orientation and a low-airflow orientation. Airflow can be adjusted by separating, rotating and re-coupling the atomizing unit and the battery unit. In other embodiments, the heater of the atomizer of an atomizing unit includes more than one heating element, and the number of heating elements activated when in use can be controlled with a control switch on the battery unit, regardless of the orientation of the atomizing unit relative to the battery unit when coupled. In yet other embodiments, the atomizing unit interface and the battery unit interface are provided with complementary recesses and projections to prevent rotation of the atomizing unit interface relative to the battery unit interface when coupled.

### RELATED APPLICATIONS

This application claims benefit of priority to China Utility Model patent application No. 202321465592.5 filed Jun. 8, 2023 and to China Utility Model patent application No. 202420629678.5 filed Mar. 28, 2024. Said applications Nos. 202321465592.5 and 202420629678.5 are hereby incorporated in their entirety herein.

### TECHNICAL FIELD

The present disclosure relates to electronic atomization systems.

### BACKGROUND

Electronic atomization systems such as vapes generate an aerosol from an atomizable substance and allows delivery of ingredients such as medicaments, nicotine and/or flavourings by inhalation of the aerosol. Pod-type electronic atomization systems typically include a battery unit and an atomizing unit. The atomizing unit, such as a vape pod, is coupled with the battery unit to form the electronic atomization system. Vape pods have a reservoir containing an atomizable substance such as an e-liquid, and a heater for generating an aerosol from the atomizable substance. The battery unit supplies power to the heater of the atomizing unit.

### BRIEF DESCRIPTION OF THE DRAWINGS

In drawings which illustrate by way of example only embodiments of the invention, in which like reference numerals describe similar items throughout the various figures,

FIG. 1 is a perspective view of an example of an electronic atomization system in a high-airflow orientation;

FIG. 2 is a top perspective view of an atomizing unit;

FIG. 3 is a bottom perspective view of the atomizing unit of FIG. 2;

FIG. 4 is a front elevation view of the atomizing unit of FIG. 2;

FIG. 5 is a right-side elevation view of the atomizing unit of FIG. 2;

FIG. 6 is a rear elevation view of the atomizing unit of FIG. 2;

FIG. 7 is a left-side elevation view of the atomizing unit of FIG. 2;

FIG. 8 is a bottom plan view of the atomizing unit of FIG. 2;

FIG. 9 is an exploded view of the atomizing unit of FIG. 2;

FIG. 10 is a top perspective view of a battery unit;

FIG. 11 is a cross-sectional view of the battery unit taken along plane line A-A of FIG. 10;

FIG. 12 is a right-side elevation view of the battery unit of FIG. 10;

FIG. 13 is a top plan view of the battery unit of FIG. 10;

FIG. 14 is front elevation view of the electronic atomization system in a low-airflow orientation;

FIG. 15 is a schematic illustrating separation of the atomizing unit from the battery unit and rotation of the atomization unit relative to the battery unit;

FIG. 16 is a bottom front perspective view of another embodiment of an atomizing unit;

FIG. 17 is a bottom rear perspective view of the atomizing unit of FIG. 16;

FIG. 18 is a schematic illustration of an example heater of the atomizing unit of FIG. 16;

FIG. 19 is a top perspective view of another battery unit for use with the atomizing unit of FIG. 16; and

FIG. 20 is a schematic illustration of the pairing of electrodes of the heater of FIG. 18 with electrodes of the battery unit of FIG. 19 in a low-airflow orientation.

### DETAILED DESCRIPTION

Among other benefits and advantages, provided herein are pod-type electronic vape systems that incorporate functionally efficient mechanisms for a user to conveniently adjust functions of an electronic atomization system, such as a heating level of the atomizing unit, or airflow volume through the atomizing unit. There is also a need to prevent purportedly-compatible atomizing units and battery units supplied by third parties from being used with battery units and atomizing units of original equipment manufacturers (OEMs), as such third-party battery units and atomizing units can pose a significant risk of damage to the OEM product and could also pose a safety hazard to the user.

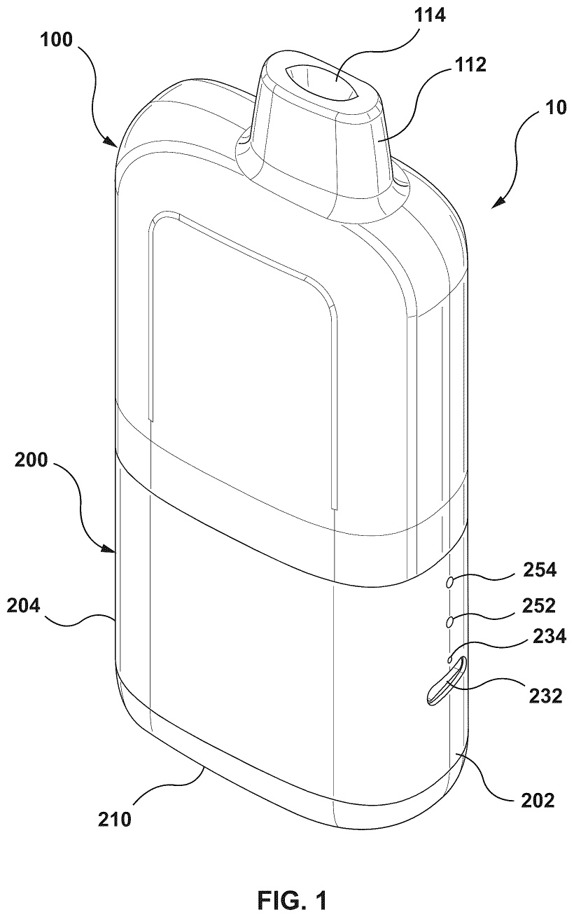

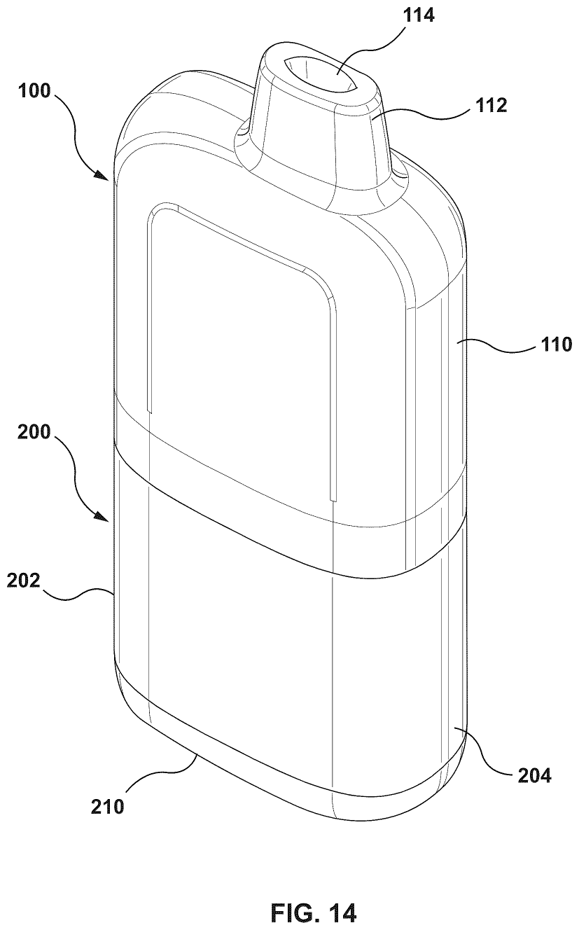

An embodiment of an electronic atomization system 10 for generating an aerosol for inhalation by a user is shown in FIGS. 1 and 14. The electronic atomization system 10 is an assembly comprising an atomizing unit 100 and a battery unit 200. In the illustrated embodiment, the atomizing unit is in the form of a vape pod of a closed-pod system, however it will be understood that an open-pod system or other types of atomizing units could also be used. The battery unit 200 supplies power to the atomizing unit 100.

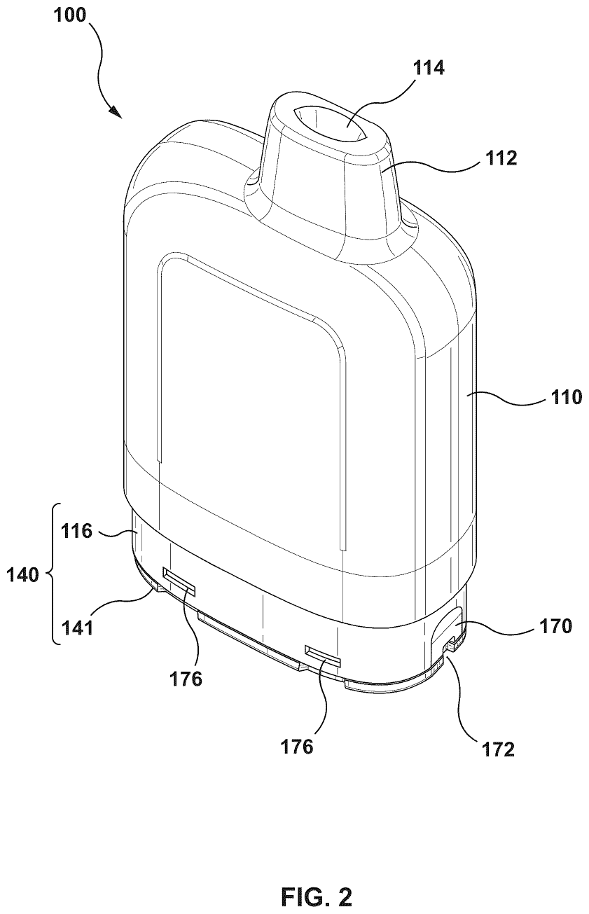

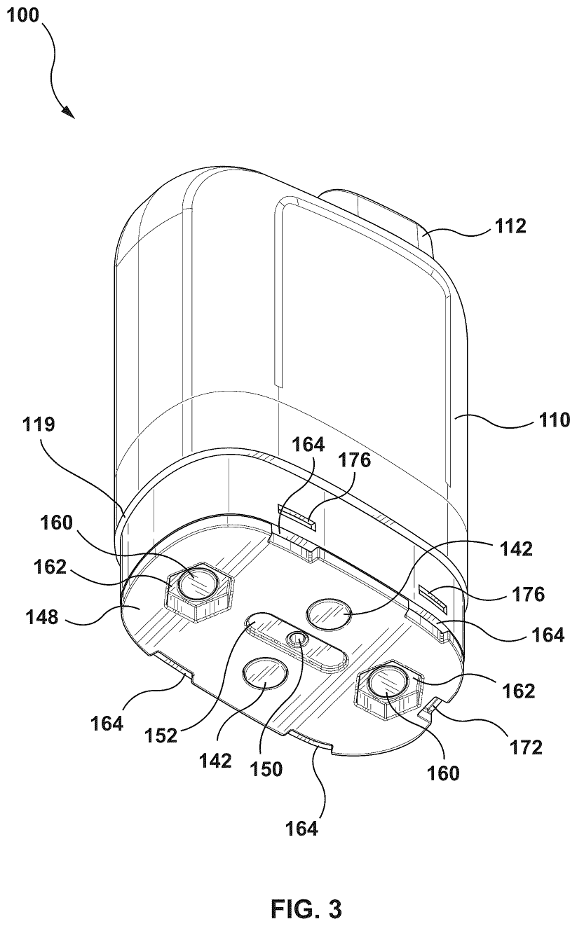

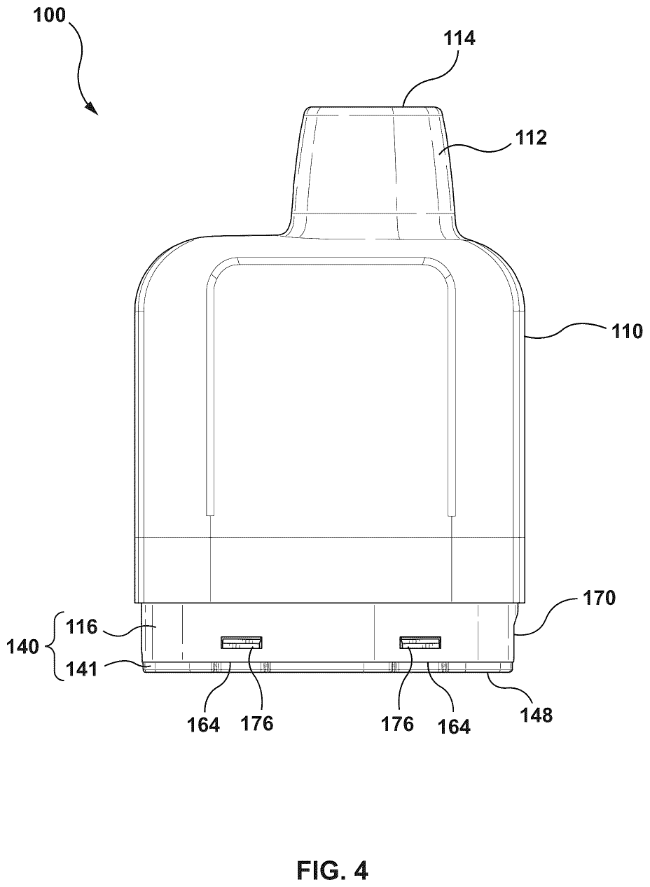

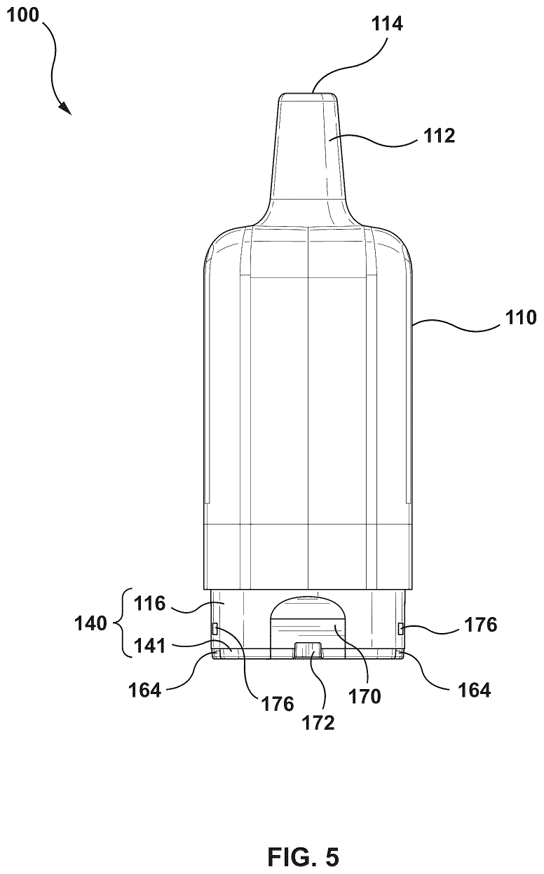

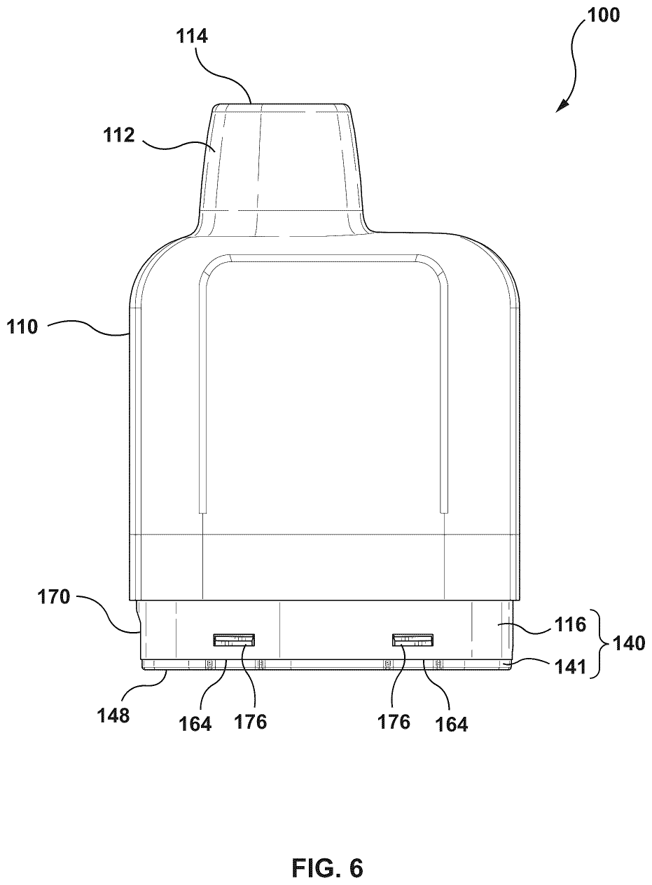

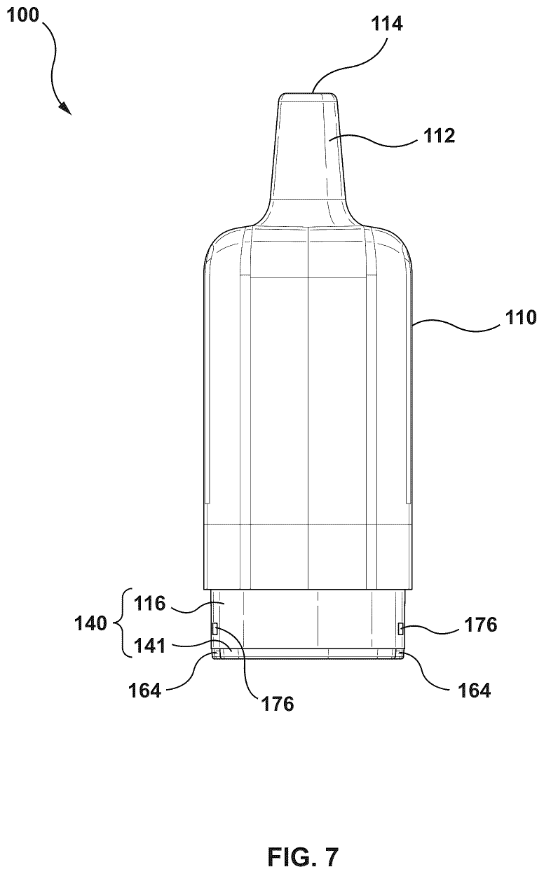

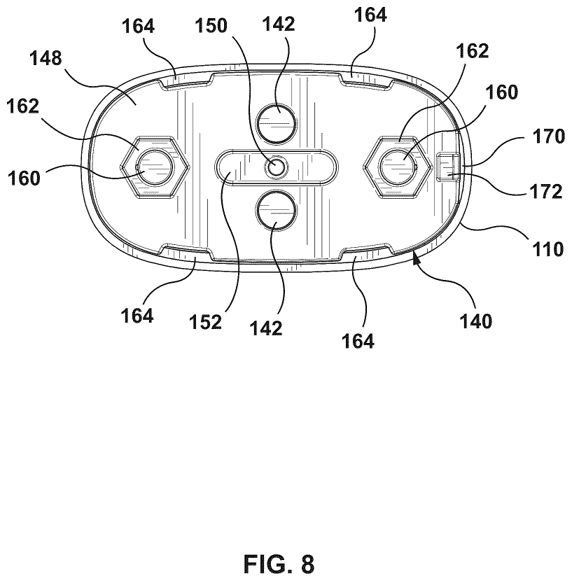

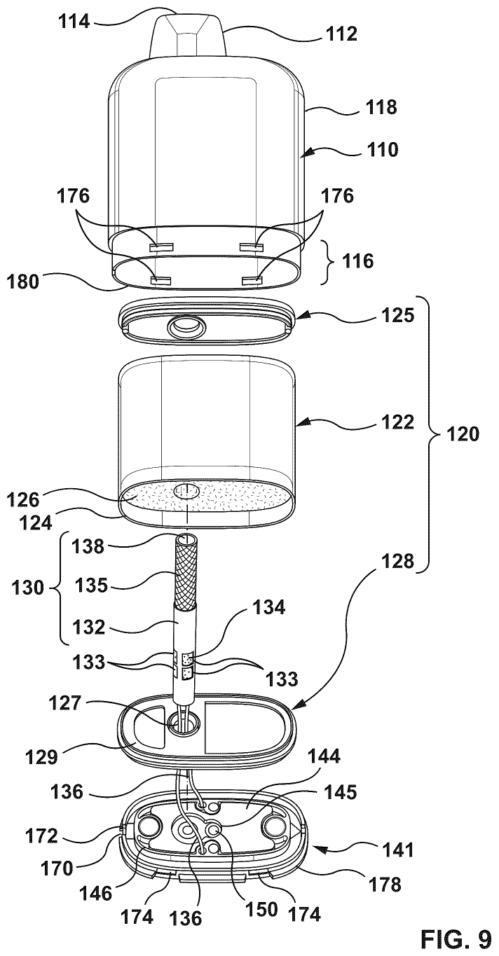

The atomizing unit 100 shown in FIGS. 2 to 9 has a pod housing 110 on which there is a mouthpiece 112 and an atomizing unit interface 140. As can be seen in FIG. 9, the pod housing 110 contains a reservoir 120 and an atomizer 130. The reservoir 120 may include a chamber 122 for containing an atomizable substance.

The chamber 122 may, for example, contain an absorbent material such as cotton or a sponge-like foam soaked with an e-liquid 126. The e-liquid may contain nicotine, as well as propylene glycol, vegetable glycerin or glycerol, water and/or other chemicals such as flavourings. The chamber 122 may include a chamber body 124, a top lid 125 and a bottom lid 128. The chamber body 124 may be made of a rigid material, while the top and bottom lids 125, 128 may be made of a resilient material such as silicone to seal against the rigid chamber body 124 to prevent the atomizable substance 126 from escaping the chamber 122 before it is aerosolized.

In the illustrated example, the atomizer 130 comprises a tubular wick 134 within a support tube 132. A heater having a heating element (not shown), such as heating coils or heating wires, is embedded in or otherwise in contact with the inner surface of the wick 134. Wires 136 electrically connect the heating element to electrical terminals 142 of the atomizing unit interface 140. The support tube 132 provides structural support for the atomizer 130, and in particular the wick 134. The support tube 132 and the wick 134 and heating element therein are located within the chamber 122. The support tube 132 has one or more openings 133 through its wall to allow the wick 134 to contact the atomizable substance 126 in the chamber 122 and absorb the atomizable substance 126 (i.e., the wick 134 is in fluid connection with the atomizable substance 126), and when heated by the heating element, an aerosol is generated from the atomizable substance 126. The aerosol is carried by airflow through the tubular channel 138 defined by the wick 134 and a liquid-impermeable tube 135 to the mouthpiece 112. The tube 135 may be made of a textile material and guides the airflow from the atomizer 130 to the mouthpiece 112. It will be understood that atomizer 130 is but one example and that other types of atomizers may be employed.

As can be seen in FIGS. 2 to 7, the mouthpiece 112 is shaped to define a mouthpiece opening 114 for passage of the aerosol generated by the electronic atomization system 10 out of the atomization unit 100 when the user takes a draw (i.e., inhales through the mouthpiece 110 causing air to flow out of the mouthpiece opening 114). The mouthpiece 112 may be a separate component that is attached to the pod housing 110, or may be integrally formed with the pod housing 110.

In the illustrated example shown in FIG. 9, the atomizing unit interface 140 comprises an interface cap 141 and an atomizing unit interface portion 116 of the pod housing 110. The atomizing unit interface 140 may be arranged at one end of the atomizing unit 100 or other appropriate positions, and preferably at the opposite end of the atomization unit from the mouthpiece 112. The interface cap 141 has an interior facing surface 146, and an exterior facing surface 148. An absorbent pad 144, made of an absorbent material such as a sponge-like foam or cotton may be provided on the interior facing surface 146 as a precaution to absorb any atomizable substance 126 in case the chamber 122 leaks. Electrical terminals 142 may be plates on the exterior facing surface 148 with electrical connection points passing through the interface cap 141 and exposed on the interior facing surface 146 for connection with the wires 136 by any means, such as soldering or with an electrical connector.

The interface cap 141 of the atomizing unit interface 140 defines an atomizer air intake opening 150 through which air enters the atomizing unit 100. The atomizer air intake opening 150 may be centrally located in an elongated recess 152 on the exterior facing surface 148. In other embodiments, the atomizer air intake opening 150 may not be centrally located and there may be more than one atomizer air intake opening. The elongated recess 152 may be provided to accommodate and facilitate airflow from a raised opening 250 on the battery unit interface 240 (described in greater detail below) into the atomizer air intake opening 150 as the raised opening 250 is closer to the right side 202 of the upwardly facing surface than the left side 204 and is thus staggered from the centrally located atomizer air intake opening 150 when the atomizing unit interface 140 is coupled to the battery unit interface 240. The elongated recess 152 may be located between the hexagonal recesses 162.

The bottom lid 128 of chamber 122 defines an air intake opening 127 therethrough for passage of air into channel 138 of the atomizer 130. The air intake opening 127 may be shaped at the interior surface 129 of the bottom lid 128 to receive and retain the bottom of atomizer 130. As opening 127 of the illustrated embodiment is not vertically aligned with the atomizer air intake opening 150, an opening 145, such as a cutout from pad 144 is shaped to allow air to flow from the atomizer air intake opening 150 to the opening 127 in bottom lid 128. An inner airflow channel from the atomizer air intake opening 150, through the cutout 145, air intake opening 127, and atomizer channel 136 to mouthpiece opening 114 is therefore provided. Holes may also be provided through the bottom lid 128 near the air intake opening 127 for passage of wires 136.

The atomizing unit interface 140 defines an atomizer portion of an interface channel for directing airflow toward the atomizer air intake opening 150. In the illustrated embodiment, the atomizer portion of the interface channel includes a groove 170 defined by a depression that may be radially concave in shape on the right side of the atomizing unit interface portion 116 of the pod housing 110, a cutout from the right edge of the interface cap 141, a notch 172 in the right edge of the interface cap 141, and the exterior facing surface 148 of the interface cap 141. The notch 172 may also provide a visual and tactile indicator of the orientation of the atomizing unit interface 140.

The atomizing unit interface 140 may also include means for releasably attaching the atomizing unit 100 to the battery unit 200. For example, magnets 160 may be provided on the exterior facing surface 148 for attachment by magnetic attraction to magnets 260 on the battery unit 200. Alternatively, any other means of attachment may be used, e.g., interference fit, Velcro™, etc.

The atomizing unit interface 140 may also define recesses 164 for receiving corresponding protrusions 264 from the battery unit interface 240. Similarly, the magnets 160 may be provided in recesses 162. In the illustrated embodiment, the recesses 164 are provided along the periphery of the atomizing unit interface 140 and the recesses 162 are hexagonal. It will be understood that the recesses 162 need not be along the periphery of the atomizing unit interface 140, and the recesses 162 and 164 may be of any shape to receive the corresponding protrusions 264 and pillars 262 on the battery unit interface 240, but preferably complementary to the shape of the protrusions 264 and pillars 262. It will also be understood that the atomizing unit interface 140 may be provided with protrusions instead of recesses 162, 164, or a combination of recesses and protrusions that correspond with recesses and protrusions or pillars on the battery unit interface 240. These recesses and protrusions may provide added stability to the connection between the atomizing unit 100 and the battery unit 200 when they are assembled to form the electronic atomization system 10, and use of different shapes for the recesses and protrusions make it more difficult for competitors to make compatible atomizing units for use with battery units from OEMs.

The interface cap 141 is releasably attached to the bottom of the atomizing unit interface portion 116 by tabs 174 that extend outwardly from a rim 178. The rim 178 is raised from the interior facing surface 146 of the interface cap 141. The tabs 174 fit into slots 176 through the wall of the atomizing unit interface portion 116 when the rim 178 is pressed into and sits within the bottom edge 180 of the atomizing unit interface portion 116. While tab and slot attachment is used in the illustrated embodiment, it will be understood that other means for attaching the interface cap 141 to the unit interface portion 116 may be employed. Furthermore, the interface cap 141 may alternatively be permanently attached to or integrally formed with the atomizing unit interface portion 116.

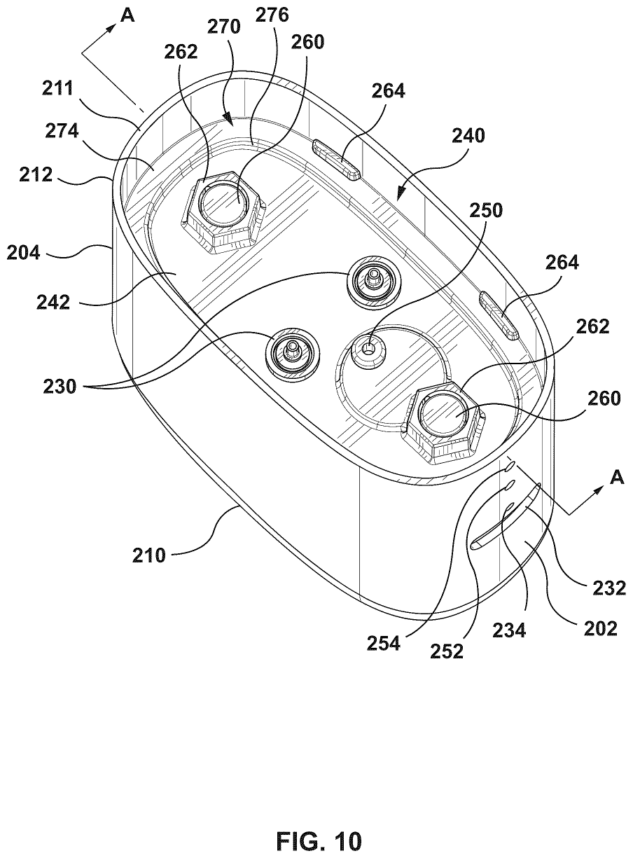

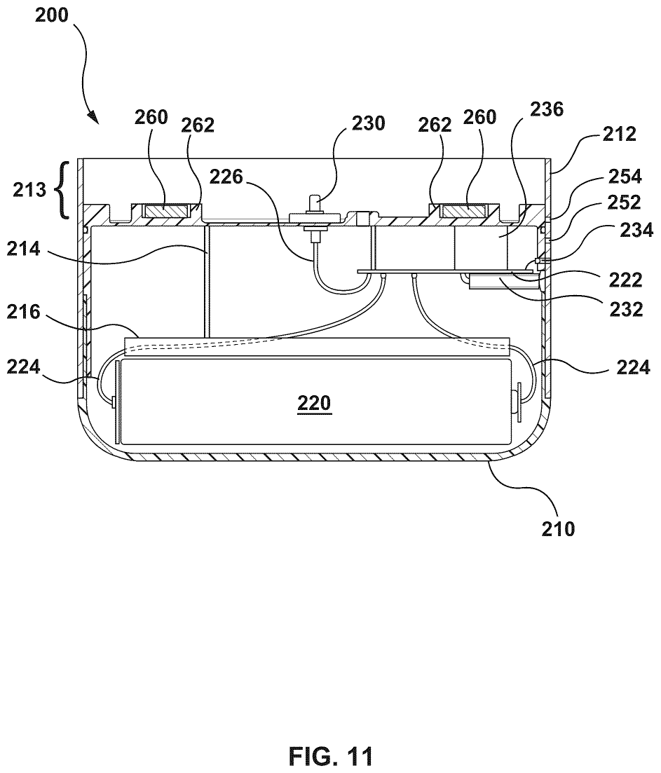

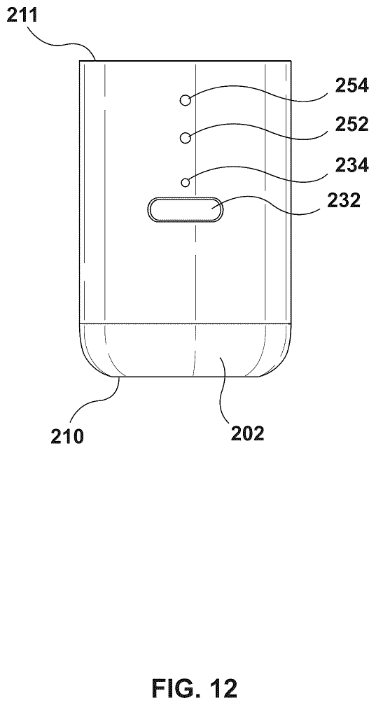

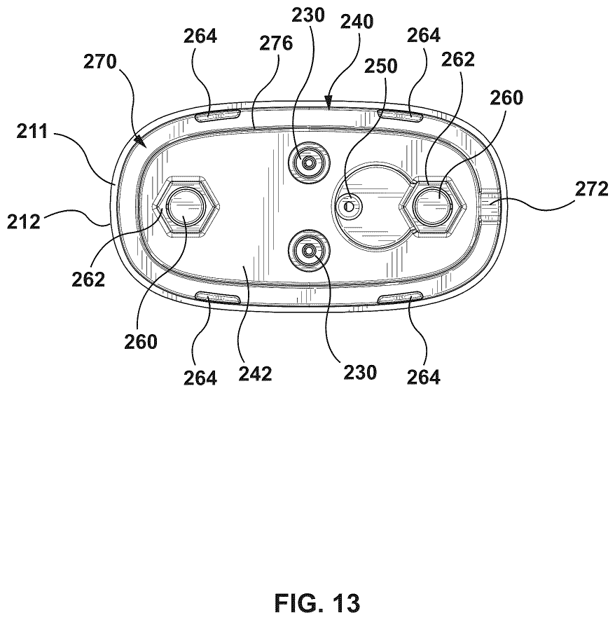

Referring to FIGS. 10 to 13, the battery unit 200 includes a housing 210 that encloses a battery 220 and circuitry amongst other things, and a battery unit interface 240 for receiving the atomizing unit interface 140. While the illustrated embodiment includes one rechargeable battery 220, in other embodiments, the battery unit 200 may include more than one battery 220. The circuitry may include a circuit board 222, wires 224 connecting the one or more batteries 220 to the circuit board 222, wires 226 connecting the circuit board to electrical terminals 230. Alternatively, the circuitry may include a printed circuit board, an integrated circuit or an application-specific integrated circuit (ASIC). The electrical terminals 230 may be spring-loaded pin connectors. A charging port 232, indicator light 234 and micro air pressure sensor 236 may also be connected to the circuit board 222. The charging port 232 is for electrical connection to a power charging cable to charge the battery 220. The charging port 232 may be a USB port, such as a USB-C port. The indicator light 234 may be used to indicate the status of an aspect of operation of the electronic atomization system 10, such as the charging status of the battery and/or the on/off status of the heating element of the atomizer 130. The indicator light 234 may be an LED or any other type of type of light. A supporting wall 214 extending from the inner surface of the battery unit interface 240 may be provided to hold the battery 220 away from the circuit board 222. Insulating padding 216 may also be provided between the battery 220 and the circuit board 222 to further prevent the battery 220 from contacting the circuit board 222.

In the illustrated embodiment, the battery unit interface 240 includes a receptacle portion 213 of outer wall 212 of housing 210, an upwardly facing surface 242, a spacer seat 270 extending from the upwardly facing surface 242, protrusions 264 extending from the spacer seat 270, pillars 262 extending from the upwardly facing surface 242, electrical terminals 230 extending through the upwardly facing surface 242 and a raised opening 250. Relative to the upwardly facing surface 242, the upper rim 211 is at a height greater than all other features of the battery unit interface 240, including the raised opening 250, the abutting surface 274 of the spacer seat 270, the upper surface of the protrusions 264, the pins of the electrical terminals 230, and the height of the pillars 262.

The spacer seat 270 is provided along the periphery of the upwardly facing surface 242 to abut the exterior facing surface 148 of the atomizing unit interface 140 such that the upwardly facing surface 242 and the exterior facing surface 148 are spaced apart when the atomizing unit 100 is coupled to the battery unit 200 to form an air channel therebetween.

The protrusions 264 are of complementary shape and size to corresponding recesses 164 in the atomizing unit interface 140. For example, the illustrated embodiment has four elongate protrusions 264 that extend upwardly from the spacer seat 270 along the outer periphery of the spacer seat 270, adjacent the inner surface of the outer wall 212. The four recesses 164 of the atomizing unit interface 140 are complementary in shape to the protrusions 264 and are therefore correspondingly elongate and dimensioned and positioned to receive the protrusions 264. When the atomizing unit 100 is assembled with the battery unit 200, the four elongate protrusions 264 are seated within the recesses 164, and the upwardly facing surface 242 of the spacer seat 270 abuts the exterior facing surface 148 of the atomizing unit interface 140.

The battery unit 200 may include means for releasably attaching the battery unit 200 to the atomizing unit 100. In the illustrated embodiment, the battery unit interface 240 has two hexagonal pillars 262. Each pillar 262 is sized, shaped and positioned to fit within hexagonal recesses 162 in the atomizing unit interface 140. Each pillar 162 may have a magnet 260 embedded therein. The attractive force between the magnets 260 in pillars 262 and the magnets 160 in recesses 162 holds the atomizing unit 100 to the battery unit 200 (i.e., releasably attaches the atomizing unit 100 to the battery unit 200) when they are assembled to form an electronic atomization system 10. The atomizing unit 100 and battery unit 200 can be detached from one another by pulling them apart with sufficient force to overcome the magnetic force between the magnets 160, 260.

It will be understood that the protrusions 264 and pillars 262 may be of any shape that fits into the recesses 164 and 162 of the atomizing unit interface 140, put are preferably complementary in shape to the recesses 164, 162. It will also be understood that the battery unit interface 240 may be provided with recesses instead of protrusions 264 and pillars 262, or a combination of recesses and protrusions or pillars that correspond with recesses and protrusions or pillars on the atomizing unit interface 140. These recesses, protrusions and pillars may provide added stability to the connection between the atomizing unit 100 and the battery unit 200 when they are assembled to form the electronic atomization system 10, and as noted above with respect to the atomizing unit 100, use of different shapes for the recesses and protrusions make it more difficult for competitors to make compatible atomizing units for use with battery units from OEMs.

The receptacle portion 213 of supporting wall 214 is shaped to slidably receive the atomizing unit interface 140. The receptacle portion 213 must therefore have a cross-section of dimensions greater than the atomizing unit interface 140. The receptacle portion 213 may have one or more outer openings therethrough, such as a first hole 252 and a second hole 254, both on the right side 202 of the illustrated example, for intake of air into the electronic atomization system 10 when assembled. While the opening into the interface channel may comprise a discrete plurality of holes 252, 254 (two are shown in the illustrated embodiment), it will be understood that in other embodiments the exterior opening into the interface channel may alternatively not consist of 2 holes, but may be formed, for example, as a single elongated opening extending longitudinally or vertically along the housing 210, as a plurality of elongated openings arranged side by side, or as a plurality of discrete apertures arranged in matrix form.

In the illustrated embodiment, the first hole 252 is located at a height above the upwardly facing surface 242 of the battery unit interface 240, and at least part of the first hole 252 is below the abutting surface 274 of the spacer seat 270. An opening 272 in the spacer seat 270 is provided about the first hole 252 so as not to obstruct airflow from the first hole 252 toward the atomizer air intake opening 150. The second hole 254 is located above the first hole 252 at a height above the abutting surface 274 of the spacer seat 270 and below the highest point of the groove 170 when the atomizing unit interface is coupled with the battery unit interface 240.

In the illustrated embodiment, the battery unit interface 240 has a raised opening 250 for air to be drawn out of the battery unit when the user inhales through the mouthpiece 112 of the atomizing unit 100 when the electronic atomization system 10 is assembled. Elongated recess 152 guides airflow from raised opening 250 toward atomizer air intake opening 150, regardless of whether the atomizing unit 100 is in the high-airflow orientation or low-airflow orientation relative to the battery unit 200.

An air pressure sensor 236 can be used as a switch to control power from the battery 220 to the heating element of the atomizer 130 in the atomizing unit 100 when coupled to the battery unit 200. In the illustrated embodiment, when the user inhales through the mouthpiece 112, air is drawn into the battery unit 200 through the charging port 232, through the air pressure sensor 236 and out of the raised opening 250 and into the atomizer 130 via the atomizer air intake opening 150. The air pressure sensor 236 detects the elevated air pressure due to the suction and causes the circuit with the battery 220 to be closed, delivering power to the heating element in the atomizer 130, thus causing the heating element to generate heat (i.e., is switched on). The heating element heats the atomizable substance 126 in the wick 134, aerosolizing the atomizable substance 126. When the air pressure is below a pre-determined level, the air pressure sensor 236 causes the circuit with the battery 220 to be open such that the heating element of the atomizer 130 does not generate heat (i.e., is switched off).

The cross-sectional shape of the inner surface of the receptacle portion 213 of the outer wall 212 and the outer cross-sectional shape of the atomizing unit interface 140 in the illustrated embodiments are elongate and symmetrical about its transverse and longitudinal axes, and sized such that the battery unit interface 240 can receive the atomizing unit interface 140 in a high-airflow orientation (as shown in FIG. 1) and a low-airflow orientation (as shown in FIG. 14).

In the high-airflow orientation, atomizing unit 100 is oriented relative to the battery unit 200 such that the second hole 254 of the battery unit interface 240 is an opening to and therefore in fluid communication with the groove 170 of the atomizing unit interface 140. An interface channel is therefore defined in part by the battery unit interface 240 and in part by the atomizing unit interface 140 to allow the passage of air from the exterior of the electronic atomization system 10 to the atomizer air intake opening 150. The first hole 252 and the second hole 254, the interior surface of the outer wall 212 around the first hole 252 within the opening 272 of the spacer seat 270 and around the second hole 254 left exposed by the groove 170 and notch 172 of the atomizing unit interface 140, the vertical walls 276 of the spacer seat 270 (including the opening 272), the upwardly facing surface 242, and other elements of the battery unit interface 240 that extend from the upwardly facing surface 242 (such as the pillars 262, electrical terminals 230 and raised opening 250), define the battery unit portion of the interface channel. The exterior facing surface 148, including the elongated recess 152, the groove 170 and the notch 172 define the atomizer portion of the interface channel. In the high-airflow orientation, air may therefore be drawn into the interface channel through the first hole 252, the second hole 254 and the raised opening 250, and pass through the interface channel to the atomizer air intake opening 150.

In the low-airflow orientation, the atomizing unit 100 is rotated 180° relative to the battery unit 200 as compared to the high-airflow orientation such that the second hole 254 of the battery unit interface 240 is blocked by the outer surface of the atomizing unit interface 140, thus preventing air from being drawn into the electronic atomization system 10 through the second hole 254. Air can be drawn through the first hole 252 regardless of whether the atomizing unit 100 is in the high-airflow orientation or the low-airflow orientation relative to the battery unit 200 as it is located, at least in part, below the abutting surface 274 of the spacer seat 270 and within the opening 272 in the spacer seat 270. In the low-airflow orientation, the battery unit portion of the interface channel is therefore defined by the first hole 252, the interior surface of the outer wall 212 around the first hole 252 within the opening 272 of the spacer seat 270, the vertical walls 276 of the spacer seat 270 (including the opening 272), the upwardly facing surface 242, and other elements of the battery unit interface 240 that extend from the upwardly facing surface 242 (such as the pillars 262, electrical terminals 230 and raised opening 250). The atomizer portion of the interface channel is defined by the exterior facing surface 148, including the elongated recess 152. In the low-airflow orientation, air may therefore be drawn into the interface channel through the first hole 252 and the raised opening 250, and pass through the interface channel to the atomizer air intake opening 150. As the total area defined by the openings through which air may be drawn into the interface channel in the low-airflow orientation is smaller than that in the high-airflow orientation, airflow into the interface channel is more restricted in the low-airflow orientation than the high-airflow orientation.

The electronic atomization system 10 is assembled by inserting the atomizing unit interface 140 of the atomizing unit 100 into the receptacle portion 213 of the battery unit 200. The magnets 160 on the atomizing unit interface 140 will be attracted to the magnet 260 on the battery unit interface 240 such that they snap together. When the atomizing unit interface 140 is couple to the battery unit interface 240, the exterior facing surface 148 of the atomizing unit 100 abuts the abutting surface 274 of the spacer seat 270 of the battery unit 200. When inserting the atomizing unit interface 140 of the atomizing unit 100 into the receptacle portion 213 of the battery unit 200, the user can select whether the assembled electronic atomization system 10 operates with high airflow or low airflow by selectively assembling the atomizing unit 100 with the battery unit 200 in the high-airflow orientation or the low-airflow orientation.

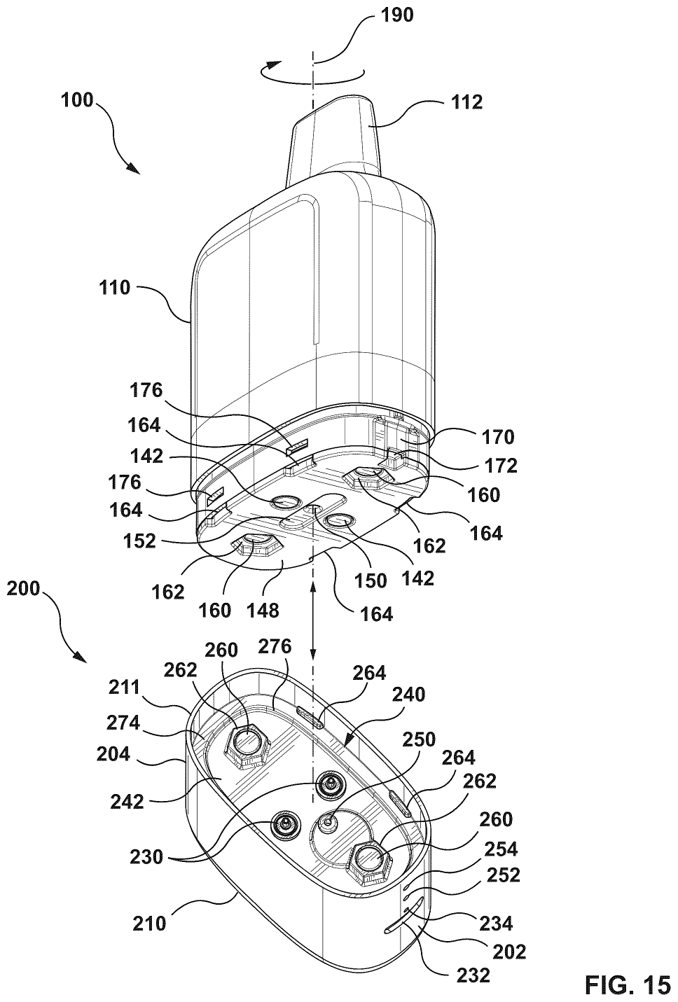

As illustrated in FIG. 15, to assemble the electronic atomization system 10 in the high-airflow orientation, before attaching the atomizing unit 100 to the battery unit 200, the atomizing unit 100 is rotated about its central vertical axis 190 relative to the battery unit 200 until the notch 172 and groove 170 are aligned with the right side 202 of the battery unit 200. The atomizing unit interface 140 is then inserted into the battery unit interface 240 so that the groove 170 is aligned with, and therefore faces, the second hole 254 when the atomizing unit interface 140 is coupled to the battery unit interface 240.

To assemble the electronic atomization system 10 in the low-airflow orientation, before attaching the atomizing unit 100 to the battery unit 200, the atomizing unit 100 is rotated about its central vertical axis 190 relative to the battery unit 200 such that the notch 172 and groove 170 are aligned with the left side 204 of the battery unit 200. The atomizing unit interface 140 is then inserted into the battery unit interface 240 so that groove 170 is misaligned with the second hole 254 such that the second hole 254 is blocked by the outer surface of the atomizing unit interface 140 when the atomizing unit interface 140 is coupled to the battery unit interface 240.

When the electronic atomization system 10 is assembled in the low-airflow orientation, the user can adjust it to operate with high airflow by pulling the atomizing unit 100 apart from the battery unit 200, rotating the atomizing unit 100 180° about its central vertical axis 190 relative to the battery unit 200 (i.e., flipping the atomizing unit 100 about its central vertical axis 190) until the notch 172 and groove 170 are aligned with the right side 202 of the battery unit 200, then re-inserting the atomizing unit interface 140 into the battery unit interface 240 so that the groove 170 is aligned with, and therefore faces, the second hole 254 when the atomizing unit interface 140 is coupled to the battery unit interface 240 (i.e., is in the high-airflow orientation). When the electronic atomization system 10 is assembled in the high-airflow orientation, the user can adjust it to operate with low airflow by pulling the atomizing unit 100 apart from the battery unit 200, rotating the atomizing unit 100 about its central vertical axis 190 relative to the battery unit 200 (i.e., flipping the atomizing unit 100 about its central vertical axis 190) until the notch 172 and groove 170 are aligned with the left side 204 of the battery unit 200, then re-inserting he atomizing unit interface 140 into the battery unit interface 240 so that groove 170 is misaligned with the second hole 254 such that the second hole 254 is blocked by the outer surface of the atomizing unit interface 140 when the atomizing unit interface 140 is coupled to the battery unit interface 240 (i.e., is in the low-airflow orientation).

Optionally, the outer cross-sectional dimensions of the atomizing unit interface portion 116 may be smaller than the outer cross-sectional dimensions of the main body 118 of the housing 110, and the cross-sectional dimensions of the outer wall 212 of the battery unit 200 may be the same as that of the main body 118, and the depth of the atomizing unit interface 140 may be the same as the depth of the receptacle portion 213 such that when the atomizing unit interface 140 is coupled to the battery unit interface 240, an overhang 119 of the housing 110 sits on the upper rim 211 of the outer wall 212 of the battery unit 200, and the external surface of the outer wall 212 of the battery unit 200 is flush with the external surface of the main body 118 of the housing 110 of the atomizing unit 100.

As the atomizing unit interface 140 must be capable of coupling with the battery unit interface 240 in both the high-airflow orientation and the low-airflow orientation, the protrusions 264 and pillars 262 with magnets 260, and corresponding recesses 164 and recesses 162 with magnets 160, whether on atomizing unit interface 140 or the battery unit interface 240, must be dimensioned and positioned to mate and therefore allow coupling in either orientation. In the illustrated embodiments, this is achieved by providing 4 elongate recesses 164 that are identical in dimension and positioned symmetrically about both longitudinal and lateral axes of the atomizing unit interface 140 that are complementary to 4 elongate protrusions 264 that are identical in dimension and positioned symmetrically about both longitudinal and lateral axes of the battery unit interface 240. There is therefore one elongate recess 164 in each quadrant of the exterior facing surface 148 of the atomizing unit interface 140 and one protrusion 264 in each quadrant of the upwardly facing surface 242 of the battery unit interface 240. In some embodiments, each recess 164 and protrusion 264 may be located at a 45° angle into its quadrant. The 2 hexagonal recesses 162 with magnets 160 are also identical in dimension and positioned along and are symmetrical about the longitudinal axis and positioned symmetrically about the lateral axis of the atomizing unit interface 140, and are complementary to the 2 hexagonal pillars 262 with magnets 260 that are identical in dimension and positioned along and symmetrical about the longitudinal axis and positioned symmetrically about the lateral axis of the battery unit interface 240. The hexagonal recesses 162 and pillars 262 are proximate each end of the exterior facing surface 148 and upwardly facing surface 242, respectively. Electrical terminals 142 are positioned along the lateral axis and positioned symmetrically about the longitudinal axis of the atomizing unit interface 140 (i.e., on either side of the centrally located atomizer air intake opening 150), and electrical terminals 230 are similarly positioned along the lateral axis and positioned symmetrically about the longitudinal axis of the battery unit interface 240 to contact the electrical terminals 142 of the atomizing unit interface 140 to form an electrical connection when the atomizing unit interface 140 and the battery unit interface 240 are coupled in either high-airflow or low-airflow orientation.

It will be understood that while the cross-sectional shape of the inner surface of the receptacle portion 213 of the outer wall 212 of the battery unit interface 240 and the outer cross-sectional shape of the atomizing unit interface 140 in the illustrated embodiments are elongate and symmetrical, other cross-sectional shapes may be used, so long as they are of such geometries and dimensions that the battery unit interface 240 can receive the atomizing unit interface 140 in multiple orientations and the atomizing unit interface is prevented from rotating when coupled to the battery unit interface 240. Rotation of the atomizing unit interface 140 when coupled to the battery unit interface 240 is undesirable as it could compromise contact of the electrical terminals 230 on the battery unit interface 240 to the electrical terminals 142 on the atomizing unit interface 140. By preventing rotation of the atomizing unit interface 140 relative to the battery unit interface 240 when they are coupled, stability of the connection of the electrical terminals 230 on the battery unit interface 240 to the electrical terminals 142 on the atomizing unit interface 140 is improved. To change the orientation of the atomizing unit interface relative to the battery unit interface to adjust between operational modes, which may include, but is not limited to various levels of airflow, the atomizing unit is separated from the battery unit, rotated and reinserted in a different orientation. For example, the cross-sectional shape of the inner surface of the receptacle portion of the outer wall of the battery unit interface and the outer cross-sectional shape of the atomizing unit interface may be substantially an equilateral triangle with the atomizing unit interface and the battery unit interface configured to define an interface channel in a low-airflow orientation, an intermediate-airflow orientation and a high-airflow orientation. Other potential cross-sectional shapes are ellipses and regular polygons.

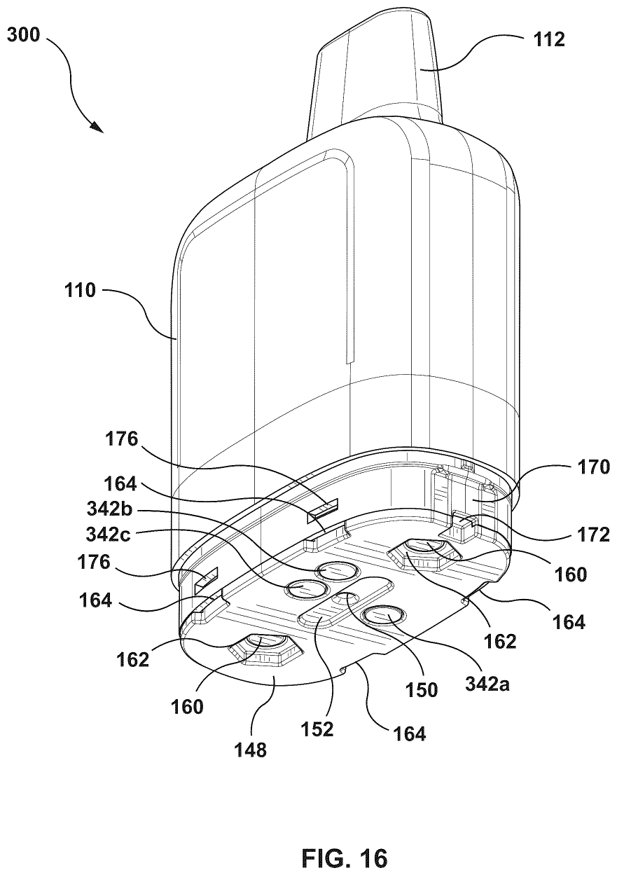

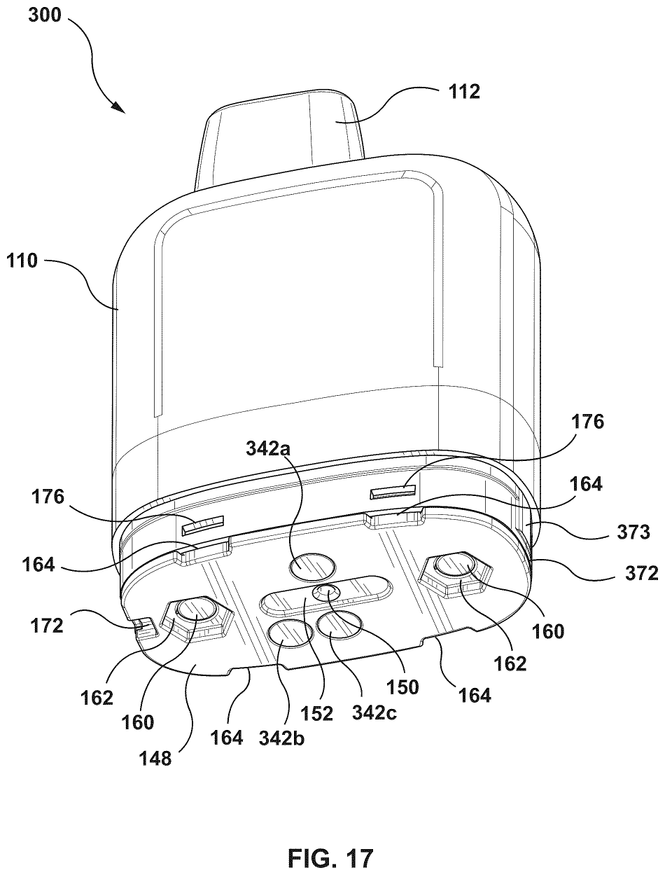

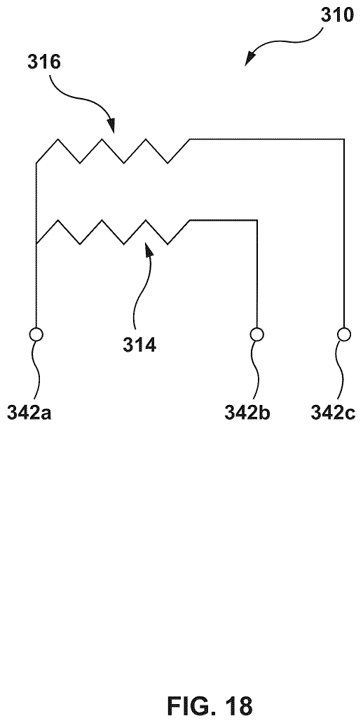

Another embodiment of an atomizing unit 300 is shown in FIGS. 16 and 17 in which features identified by the same reference numerals as atomizing unit 100 are aptly described above with reference to those same reference numerals. However, atomizer 130 of atomizing unit 300 includes a heater 310 having 2 or more heating elements. In the embodiment illustrated schematically in FIG. 18, the heater 310 has a first heating element 314 electrically connected in parallel to a second heating element 316. Each heating element 314, 316 may comprise one or more heating coils or heating wires embedded in the wick 134. The negative electrodes of both the first heating element 314 and the second heating element 316 are electrically connected to a first electrical terminal 342a. The positive electrode of the first heating element 314 is electrically connected to a second electrical terminal 342b, and the positive electrode of the second heating element 316 is electrically connected to a third electrical terminal 342c. The externally facing portions of the first, second and third electrical terminals 342a, 342b, 342c are preferably flush with the exterior facing surface 148 of the atomizing unit interface 140. The first electrical terminal 342a and the third electrical terminal 342c may be positioned along the transverse axis of the atomizing unit interface 140, symmetrically about the longitudinal axis of the atomizing unit interface 140, and the second electrical terminal 342b may be arranged side by side with the third electrical terminal 342c. Alternatively, multiple electrical terminals can be arranged circumferentially along a circle, or on the vertices of polygons such as a quadrilateral, pentagon, hexagon, heptagon or octagon, such that the electrical terminals 342a, 342b, 342c can be in electrical contact with electrical terminals 230 or 430a, 430b, 430c and/or 430d of the battery unit interface 240 when coupled thereto in various orientations of the electrical atomization system 10.

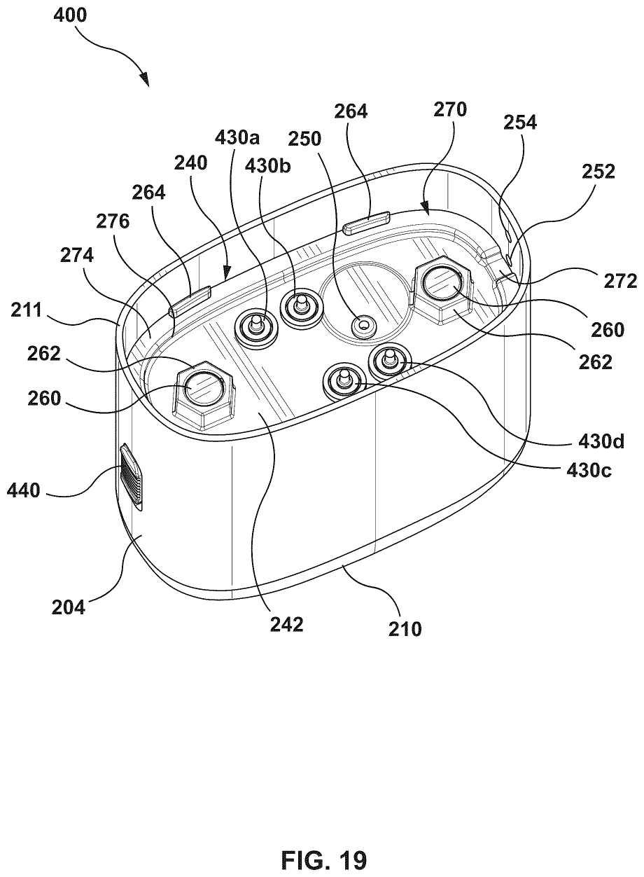

The atomizing unit interface 140 may include a second air intake channel 372 (shown in FIG. 17) at a different position on the atomizing unit interface 140 from the groove 170. The second air intake channel 372 may be formed by the lower side surface of the atomizing unit interface 140, or may be a depression in the lower side surface of the atomizing unit interface 140. The depression may be radially concave in shape. The second air intake channel 372 forms part of the atomizer portion of the interface channel in the low-airflow orientation. The second air intake channel 372 is located below and adjacent a stop portion 373 of the atomizing unit interface portion 115. When the atomizing unit interface 140 is coupled to the battery unit interface 240, the stop portion 373 contacts the inner surface of outer wall 212 of the housing 210 of the battery unit 200, 400 (shown in FIG. 19), and is positioned to block the second hole 254 in the low-airflow orientation, thus reducing air intake as compared to the high-airflow orientation.

Another embodiment of a battery unit 400 is shown in FIG. 19. The battery unit interface 240 of battery unit 400 includes more than 2 electrical terminals. 4 electrical terminals 430a, 430b, 430c and 430d are shown in the embodiment of FIG. 19. The electrical terminals 430a, 430b, 430c and 430d may be spring-loaded pin connectors to increase the reliability of contact with the electrical terminals 342a, 342b, 342c of the atomizing unit interface 140 when the battery unit interface 240 is coupled to the atomizing unit interface 140. The electrical terminals 430a, 430b, 430c and 430d may be arranged parallel to each other, where the first electrical terminal 430a and the second electrical terminal 430b are arranged side by side as shown in FIG. 19, the third electrical terminal 430c and the fourth electrical terminal 430d are arranged side by side, and the first electrical terminal 430a and the second electrical terminal 430b are parallel to the third electrical terminal 430c and the fourth electrical terminal 430d, so that the first, second, third and fourth electrical terminals 430a, 430b, 430c and 430d form a parallelogram. However, it will be understood that the electrical terminals on the battery unit interface 240 may also be arranged in other ways, such as in a circular arrangement, as long as electrical contact can selectively be made with the electrical terminals 342a, 342b, 342c on the atomizing unit interface 140 when the battery unit 400 and the atomizing unit 300 are coupled.

The electrical terminals 430a, 430b, 430c, 430d may also be electrically connected to a control switch 440 on the housing 210 of the battery unit 400, such that each electrical terminal 430a, 430b, 430c, 430d is controlled by the control switch 440, which in turn controls via contact with the electrical terminals 342a, 342b, 342c of the atomizing unit interface 140 whether each heating element 314, 316 is electrically connected to the heating circuit, and/or controls the electrical connection mode of each heating element, etc., to adjust the working mode of the heater 310 and therefore the working mode of the atomizer 130. For example, the working mode of the heater can be adjusted by actuating the control switch 440 to a first setting such that only one of the first heating element 314 or the second heating element 316 is activated at a time when the air pressure sensor 236 detects elevated air pressure as the user inhales through the mouthpiece 112, or by actuating the control switch 440 to a second setting such that both the first heating element 314 and the second heating element 316 is activated when the air pressure sensor 236 detects elevated air pressure as the user takes a draw. In the first setting, the circuitry may also be configured to cause the first heating element 314 and the second heating element 316 to activate alternately with each draw by the user so as to prevent wearing out one heating element before the other, thereby preserving the longevity of the atomizer 130. That is, in the first setting, one draw may active the first heating element 314, the next draw activates the second heating element 316, the next draw activates the first heating element 314 and so on. The control switch may have additional settings, for example if the atomizer 130 has additional heating elements to control activation of those additional heating elements, or to turn the heater 310 off so that it cannot be activated by the air pressure sensor 236.

The control switch 440 may be a single integrated switch where the working mode of the heater is controlled by various gears or settings of the single integrated switch. Alternatively, the control switch 440 may comprise a plurality of switches, where each switch is individually electrically connected to each electrical terminal 430a, 430b, 430c, 430d.

The various electrical terminals 430a, 430b, 430c and 430d of the battery unit 400 may be electrically connected to one or more control switches, preferably a single control switch, to control the operating mode of the heater 310 and thus change the operating mode of the atomizing unit 100.

When the atomizing unit 300 is coupled to the battery unit 400 in the low-airflow orientation, the first electrical terminal 342a (which in this example is a negative electrode) of the atomizing unit interface 140 is in electrical contact with the third electrical terminal 430c of the battery unit interface 240, the second electrical terminal 342b of the atomizing unit interface 140 is in electrical contact with the first electrical terminal 430a of the battery unit interface 240, and the third electrical terminal 342c of the atomizing unit interface 140 is in electrical contact with the second electrical terminal 430b of the battery unit interface 240, the controller of the electronic atomization system recognizes the negative electrode and controls the first electrical terminal 430a and the second electrical terminal 430b of the battery unit interface 240 to correspond with the polarity of the second electrical terminal 342b and the third electrical terminal 342c of the atomizing unit interface 140, thereby closing the circuit to supply power to the heater 310. The working mode of the heater 310 can be changed by toggling the control switch 440 to control whether the first electrical terminal 430a and/or the second electrical terminal 430b of the battery unit interface 240 are electrically connected to the circuit, or whether they are to be connected to the circuit in series or in parallel. The control mechanism of the control switch 440 and the means of electrically connecting the heating elements 314, 316 to the control switch 440 may be any means known in the art.

When the atomizing unit 300 is coupled to the battery unit 400 in the high-airflow orientation, the first electrical terminal 342a (which in this example is a negative electrode) of the atomizing unit interface 140 is in electrical contact with the second electrical terminal 430b of the battery unit interface 240, the second electrical terminal 342b of the atomizing unit interface 140 is in electrical contact with the fourth electrical terminal 430d of the battery unit interface 240, and the third electrical terminal 342c of the atomizing unit interface 140 is in electrical contact with the third electrical terminal 430c of the battery unit interface 240, the controller of the electronic atomization system recognizes the negative electrode and controls the fourth electrical terminal 430d and the third electrical terminal 430c of the battery unit interface 240 to correspond with the polarity of the second electrical terminal 342b and the third electrical terminal 342c of the atomizing unit interface 140, thereby closing the circuit to supply power to the heater 310. The working mode of the heater 310 can be changed by toggling the control switch 440 to control whether the third electrical terminal 430c and/or the fourth electrical terminal 430d of the battery unit interface 240 are electrically connected to the circuit, or whether they are to be connected to the circuit in series or in parallel.

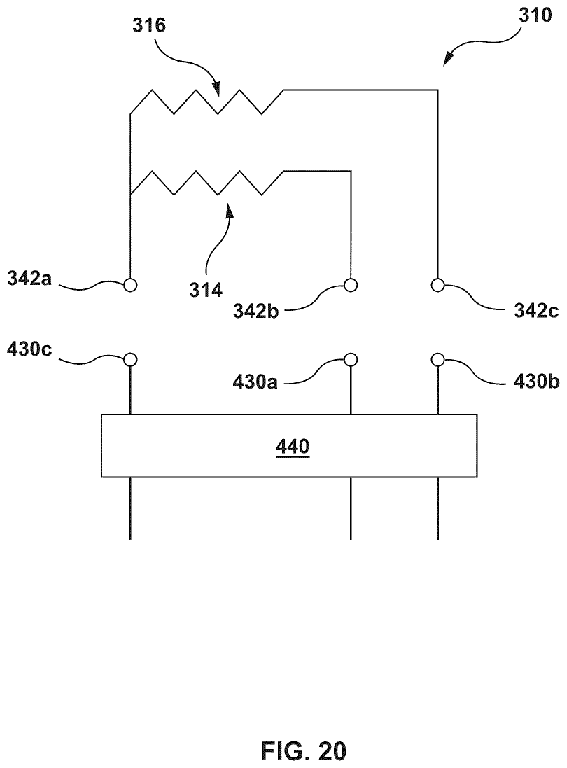

FIG. 20 shows, in one particular example embodiment, heater 310. Heater 310 includes heating elements 314, 316 arranged in parallel, electrically coupled to electrical terminals 342a, 342b and 342c. Heating elements 314, 316 are interfaced to the atomizing unit via electrical terminals 430a, 430b, 430c of the atomizing unit, in one example embodiment as depicted.

In this description, relative spatial terms such as “interior”, “exterior”, “top”, “bottom”, “left”, “right”, “front”, “rear”, “horizontal”, “vertical”, etc. are used to describe individual parts and their connections as they appear in the figures, but are not intended to be limiting in any way. When the orientation of a part is changed, their relative spatial relationships can also be reversed or changed without affecting the scope of the present invention.

Although embodiments are described in detail herein with reference to the accompanying drawings, it is contemplated that the disclosure herein is not limited to only such literal embodiments. As such, modifications and equivalents of the atomization system and variations in sequence of the method steps in conjunction with varying combinations of features disclosed herein will be apparent to practitioners skilled in this art.

Furthermore, it is contemplated that particular features described either individually or as part of an embodiment can be combined with other individually described features, or parts of other embodiments described herein. In particular, such describing combinations include, without limitation:

An atomizing unit for assembly with a battery unit to form an electronic atomization system. The atomizing unit comprises a reservoir to containing an atomizable substance; an atomizer in fluid connection with the reservoir for generating an aerosol from the atomizable substance and having means for receiving power from the battery unit; a mouthpiece defining a mouthpiece opening for egress of the aerosol for inhalation by a user; an atomizing unit interface for coupling with a battery unit interface of the battery unit, the atomizing unit interface defining an atomizer air intake opening; an inner airflow channel for channeling airflow from the atomizer air intake opening, to and through the atomizer, and to the mouthpiece opening, the atomizing unit interface having a cross-sectional geometry complementary to a battery unit interface portion of the battery unit to allow the atomizing unit to be coupled with the battery unit in at least a high-airflow orientation and a low-airflow orientation; the atomizing unit interface defining an atomizer portion of an interface channel for directing airflow toward the atomizer air intake opening, the atomizer portion of the interface channel positioned to be aligned with a battery unit portion of the interface channel defined by the battery unit interface when the atomizing unit interface is coupled with the battery unit interface in the high-airflow orientation such that one or more outer openings through which air can be drawn into the interface channel has a first total area, and the atomizer portion of the interface channel positioned to be misaligned with at least a portion of the battery unit portion of the interface channel when the atomizing unit interface is coupled to the battery unit interface in the low-airflow orientation such that the one or more outer openings through which air can be drawn into the interface channel has a second total area that is less than the first total area, such that airflow into the inner airflow channel can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface to the battery unit interface in the high-airflow orientation or the low-airflow orientation.

In embodiments, the one or more outer openings is defined by the battery unit interface, and the atomizing unit interface defines a groove that is part of the atomizer portion of the interface channel, the groove being dimensioned and positioned such that when the atomizing unit interface is coupled to the battery unit interface in the high-airflow orientation, the groove is aligned with the one or more outer openings, such that airflow through the one or more openings is not obstructed by the atomizing unit interface, and when the atomizing unit is coupled with the battery unit in the low-airflow orientation, at least a portion of the at least one outer openings is obstructed by the atomizing unit interface.

In another aspect, the one or more outer openings comprises a first hole and a second hole through an outer wall of the battery unit interface, and when the atomizing unit interface is coupled to the battery unit interface in the high-airflow orientation, the second hole is aligned with the groove such that airflow through the first hole and the second hole are not obstructed by the atomizing unit interface, and when the atomizing unit is coupled with the battery unit in the low-airflow orientation, at least some of the first hole is not obstructed by the atomizing unit interface while the second hole is obstructed by the atomizing unit interface.

In embodiments, the atomizing unit interface has an outer cross-sectional geometry that can be slidably received by the battery unit interface when coupling the atomizing unit interface to the battery unit interface. In variations, the outer cross-sectional geometry of the atomizing unit interface is symmetrical about its transverse and longitudinal axes.

In some aspects, the atomizing unit interface is configured to be releasably attached to the battery unit interface when the atomizing unit interface is coupled with the battery unit interface. In one embodiment, the atomizing unit interface has at least one magnet for the atomizing unit interface to be releasably attached to the battery unit interface by an attractive force between the at least one magnet in the atomizing unit interface and at least one magnet in the battery unit interface. In one variation, the atomizing unit interface has first recesses or pillars positioned along a longitudinal axis of the atomizing unit interface and symmetrically about a transverse axis of the atomizing unit interface, and one of the at least one magnets is embedded in each of the first recesses or pillars, the first recesses or pillars dimensioned and positioned to receive complementary pillars or be received by complementary recesses on the battery unit interface when the atomizing unit interface is coupled to the battery unit interface, whether in the low-airflow orientation or the high-airflow orientation. The first recesses or pillars are regular polygonal, in some embodiments.

In embodiments, the atomizing unit interface has a plurality of second recesses or protrusions dimensioned and positioned to receive complementary protrusions or be received by complementary recesses in the battery unit interface when the atomizing unit interface is coupled to the battery unit interface, whether in the low-airflow orientation or the high-airflow orientation. In one aspect, the second recesses or protrusions are provided along the periphery of the atomizing unit interface.

In embodiments, the atomizer includes a heater with more than one heating element and each heating element can be activated independently of the other(s), the heater's working mode being controlled by a control switch on the battery unit, and the atomizing unit interface having a plurality of electrical terminals, one or more of the electrical terminals being electrically connected to the heater as negative electrodes, and the other electrical terminals being electrically connected to the heater as positive electrodes, the plurality of electrical terminals being arranged to selectively form electrical contact with electrical terminals of the battery unit interface when the atomizing unit is coupled to the battery unit, the electrical terminals of the battery unit interface electrically connected with the control switch configured to accommodate connection of the atomizing unit and the battery unit whether in a high-airflow orientation or a low-airflow orientation.

In related embodiments, also provided is a battery unit for assembly with an atomizing unit to form an electronic atomization system. The battery unit comprising a housing for enclosing one or more batteries; a battery unit interface portion having a cross-sectional geometry complementary to an atomizing unit interface of the atomizing unit to allow the battery unit to be coupled with the atomizing unit in at least a high-airflow orientation and a low-airflow orientation, the battery unit interface portion defining a battery unit portion of an interface channel for directing, in cooperation with an atomizer portion of the interface channel of an atomizing unit interface of the atomizing unit, airflow toward an atomizer intake opening of the atomizing unit, the battery unit portion of the interface channel positioned to be aligned with the atomizer portion of the interface channel when the battery unit is coupled with the atomizing unit in the high-airflow orientation such that one or more outer openings through which air can be drawn into the interface channel has a first total area, and the battery portion of the interface channel positioned to be misaligned with at least a portion of the atomizer portion of the interface channel when the battery unit is coupled with the atomizing unit in a low-airflow orientation such that the one or more outer openings through which air can be drawn into the interface channel has a second total area that is less than the first total area, such that airflow into an inner airflow channel of the atomizing unit can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface with the battery unit interface portion in the high-airflow or low-airflow orientation;

In embodiments, the battery unit interface portion includes electrical terminals for supplying power to the atomizing unit when the atomizing unit is coupled to the battery unit; a switch for controlling power from the one or more batteries to the atomizing unit via the electrical terminals when the atomizing unit is coupled to the battery unit;

In related aspects, the one or more outer openings is defined by the battery unit interface and are dimensioned and positioned such that when the atomizing unit interface is coupled to the battery unit interface in the low-airflow orientation, a greater portion of the outer openings is obstructed by the atomizing unit interface than when the atomizing unit interface is coupled to the battery unit interface in the high-airflow orientation.

In one variation, the one or more outer openings comprises a first hole and a second hole through an outer wall of the battery unit interface, the first hole and the second hole being positioned such that when the atomizing unit interface is coupled to the battery unit interface in the high-airflow orientation, the second hole is aligned with a groove in the atomizing unit interface such that airflow through the first hole and the second hole are not obstructed by the atomizing unit interface, and when the atomizing unit is coupled with the battery unit in the low-airflow orientation, at least a portion of the first hole is not obstructed by the atomizing unit interface while the second hole is obstructed by the atomizing unit interface. In related embodiments, the switch comprises an air pressure sensor.

In some aspects, a receptacle portion of the battery unit interface has a cross-sectional geometry that is symmetrical about its transverse and longitudinal axes. In an embodiment, the battery unit interface has at least one magnet for the battery unit interface to be releasably attached to the atomizing unit interface by an attractive force between the at least one magnet in the battery unit interface and at least one magnet in the atomizing unit interface.

In related embodiments, the battery unit interface has first pillars or recesses positioned along a longitudinal axis of the battery unit interface and symmetrically about a transverse axis of the battery unit interface, and one of the at least one magnets is embedded in each of the first pillars or recesses, the first pillars or recesses dimensioned and positioned to be received by complementary recesses or to receive complementary pillars on the atomizing unit interface when the battery unit interface is coupled to the atomizing unit interface, whether in the low-airflow orientation or the high-airflow orientation.

In some embodiments, the battery unit interface further comprises a plurality of electrical terminals electrically connected with a control switch for controlling a heater in an atomizer in the atomizing unit, the electrical terminals being arranged to selectively form electrical contact with electrical terminals of the atomizing unit interface when the atomizing unit is coupled to the battery unit, the electrical terminals of the battery unit interface electrically connected with the control switch and configured to accommodate connection of the atomizing unit and the battery unit whether in a high-airflow orientation or a low-airflow orientation.

Also provided is an atomizing unit interface for coupling an atomizing unit with a battery unit interface of a battery unit for the atomizing unit and the battery unit to form an electronic atomization system when assembled. The atomization unit interface, in embodiments, includes a cross-sectional geometry complementary to a battery unit interface portion of the battery unit to allow the atomizing unit to be coupled with the battery unit in at least a high-airflow orientation and a low-airflow orientation, defining an atomizer air intake opening for air to enter the atomizing unit, and defining an atomizer portion of an interface channel for directing airflow toward the atomizer air intake opening, the atomizer portion of the interface channel positioned to be aligned with a battery unit portion of the interface channel defined by the battery unit interface when the atomizing unit interface is coupled with the battery unit interface in the high-airflow orientation such that one or more outer openings through which air can be drawn into the interface channel has a first total area, and the atomizer portion of the interface channel positioned to be misaligned with at least a portion of the battery unit portion of the interface channel when the atomizing unit interface is coupled to the battery unit interface in the low-airflow orientation such that the one or more outer openings through which air can be drawn into the interface channel has a second total area that is less than the first total area, such that airflow into the inner airflow channel can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface to the battery unit interface in the high-airflow orientation or the low-airflow orientation.

In embodiments, the one or more outer openings is defined by the battery unit interface, the atomizing unit interface defines a groove that is part of the atomizer portion of the interface channel, the groove being dimensioned and positioned such that when the atomizing unit interface is coupled to the battery unit interface in the high-airflow orientation, the groove is aligned with the one or more outer openings, such that airflow through the one or more openings is not obstructed by the atomizing unit interface, and when the atomizing unit is coupled with the battery unit in the low-airflow orientation, at least a portion of the at least one outer openings is obstructed by the atomizing unit interface.

In some aspects, the one or more outer openings comprises a first hole and a second hole through an outer wall of the battery unit interface, and when the atomizing unit interface is coupled to the battery unit interface in the high-airflow orientation, the second hole is aligned with the groove such that airflow through the first hole and the second hole are not obstructed by the atomizing unit interface, and when the atomizing unit is coupled with the battery unit in the low-airflow orientation, at least some of the first hole is not obstructed by the atomizing unit interface while the second hole is obstructed by the atomizing unit interface.

Also provided is a battery unit interface for coupling a battery unit with an atomizing unit interface of an atomizing unit for the atomizing unit and the battery unit to form an electronic atomization system when assembled. The battery unit interface, in some embodiments, comprises a cross-sectional geometry complementary to an atomizing unit interface of the atomizing unit to allow the battery unit to be coupled with the atomizing unit in at least a high-airflow orientation and a low-airflow orientation; electrical terminals for supplying power to the atomizing unit when the battery unit interface is coupled to the atomizing unit interface, defining a battery unit portion of an interface channel for directing, in cooperation with an atomizer portion of the interface channel of an atomizing unit interface of the atomizing unit, airflow toward an atomizer intake opening of the atomizing unit, the battery unit portion of the interface channel positioned to be aligned with the atomizer portion of the interface channel when the battery unit is coupled with the atomizing unit in the high-airflow orientation such that one or more outer openings through which air can be drawn into the interface channel has a first total area, and the battery portion of the interface channel positioned to be misaligned with at least a portion of the atomizer portion of the interface channel when the battery unit is coupled with the atomizing unit in a low-airflow orientation such that the one or more outer openings through which air can be drawn into the interface channel has a second total area that is less than the first total area, such that airflow into an inner airflow channel of the atomizing unit can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface with the battery unit interface in the high-airflow or low-airflow orientation.

Accordingly, it is intended that the scope of the invention be defined by the following claims and their equivalents. Furthermore, it is contemplated that a particular feature described either individually or as part of an embodiment can be combined with other individually described features, or parts of other embodiments described herein. Thus, absence of any described particular combinations of such does not preclude the inventor from claiming rights to such combinations.

What is claimed is:

1. An atomizing unit interface for coupling an atomizing unit with a battery unit interface of a battery unit for the atomizing unit and the battery unit to form an electronic atomization system when assembled, the atomization unit interface:
having a cross-sectional geometry complementary to a battery unit interface portion of the battery unit to allow the atomizing unit to be coupled with the battery unit in at least a high-airflow orientation and a low-airflow orientation;
defining an atomizer air intake opening for air to enter the atomizing unit;
defining an atomizer portion of an interface channel for directing airflow toward the atomizer air intake opening, the atomizer portion of the interface channel positioned to be aligned with a battery unit portion of the interface channel defined by the battery unit interface when the atomizing unit interface is coupled with the battery unit interface in the high-airflow orientation such that one or more outer openings through which air can be drawn into the interface channel has a first total area, and the atomizer portion of the interface channel positioned to be misaligned with at least a portion of the battery unit portion of the interface channel when the atomizing unit interface is coupled to the battery unit interface in the low-airflow orientation such that the one or more outer openings through which air can be drawn into the interface channel has a second total area that is less than the first total area, such that airflow into the inner airflow channel can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface to the battery unit interface in the high-airflow orientation or the low-airflow orientation.

2. The atomizing unit interface of claim 1, wherein the one or more outer openings is defined by the battery unit interface, the atomizing unit interface defines a groove that is part of the atomizer portion of the interface channel, the groove being dimensioned and positioned such that when the atomizing unit interface is coupled to the battery unit interface in the high-airflow orientation, the groove is aligned with the one or more outer openings, such that airflow through the one or more openings is not obstructed by the atomizing unit interface, and when the atomizing unit is coupled with the battery unit in the low-airflow orientation, at least a portion of the at least one outer openings is obstructed by the atomizing unit interface.

3. The atomizing unit interface of claim 2, wherein the one or more outer openings comprises a first hole and a second hole through an outer wall of the battery unit interface, and when the atomizing unit interface is coupled to the battery unit interface in the high-airflow orientation, the second hole is aligned with the groove such that airflow through the first hole and the second hole are not obstructed by the atomizing unit interface, and when the atomizing unit is coupled with the battery unit in the low-airflow orientation, at least some of the first hole is not obstructed by the atomizing unit interface while the second hole is obstructed by the atomizing unit interface.

4. A battery unit interface for coupling a battery unit with an atomizing unit interface of an atomizing unit for the atomizing unit and the battery unit to form an electronic atomization system when assembled, the battery unit interface:
having a cross-sectional geometry complementary to an atomizing unit interface of the atomizing unit to allow the battery unit to be coupled with the atomizing unit in at least a high-airflow orientation and a low-airflow orientation;
having electrical terminals for supplying power to the atomizing unit when the battery unit interface is coupled to the atomizing unit interface;
defining a battery unit portion of an interface channel for directing, in cooperation with an atomizer portion of the interface channel of an atomizing unit interface of the atomizing unit, airflow toward an atomizer intake opening of the atomizing unit, the battery unit portion of the interface channel positioned to be aligned with the atomizer portion of the interface channel when the battery unit is coupled with the atomizing unit in the high-airflow orientation such that one or more outer openings through which air can be drawn into the interface channel has a first total area, and the battery portion of the interface channel positioned to be misaligned with at least a portion of the atomizer portion of the interface channel when the battery unit is coupled with the atomizing unit in a low-airflow orientation such that the one or more outer openings through which air can be drawn into the interface channel has a second total area that is less than the first total area, such that airflow into an inner airflow channel of the atomizing unit can be adjusted by selectively orienting the atomizing unit relative to the battery unit in the high-airflow orientation or the low-airflow orientation when assembling the electronic atomization system, by rotating the atomizing unit relative to the battery unit when the atomizing unit is separated from the battery unit and coupling the atomizing unit interface with the battery unit interface in the high-airflow or low-airflow orientation.

5. An atomizing unit of an electronic atomization system, the atomizing unit comprising:
an atomizer for generating an aerosol from an atomizable substance, the atomizer having a heater to heat the atomizable substance, the heater's working mode being controlled by a control switch on the battery unit;
an atomizing unit interface for coupling with a battery unit interface of a battery unit to supply power to the atomizing unit, the atomizing unit interface having a plurality of electrical terminals, one or more of the electrical terminals being electrically connected to the heater as negative electrodes, and the other electrical terminals being electrically connected to the heater as positive electrodes, the plurality of electrical terminals being arranged to selectively form electrical contact with electrical terminals of the battery unit interface when the atomizing unit is coupled to the battery unit, the electrical terminals of the battery unit interface electrically connected with the control switch configured to mechanically and electrically accommodate different connection orientations of the atomizing unit and the battery unit.

6. The atomizing unit of claim 5, wherein:
the plurality of electrical terminals comprises a negative electrode and two or more positive electrodes;
the heater comprises two or more heating elements, a first end of the heating elements being electrically connected to the negative electrode, and the positive electrodes being electrically connected to the second end of the heating elements.

7. A battery unit for assembly with the atomizing unit of claim 5, the battery unit comprising:
a housing enclosing one or more batteries;
a battery unit interface portion for coupling with an atomizing unit interface, the battery unit interface comprising a plurality of electrical terminals electrically connected with the control switch for controlling the heater, the electrical terminals being arranged to selectively form electrical contact with electrical terminals of the atomizing unit interface when the atomizing unit is coupled to the battery unit, the electrical terminals of the battery unit interface electrically connected with the control switch and configured to accommodate connection of the atomizing unit and the battery unit whether in a high-airflow orientation or a low-airflow orientation.

8. An atomizing unit interface for coupling an atomizing unit with a battery unit interface of a battery unit, the atomization unit interface comprising:
at least one magnet for the atomizing unit interface to be releasably attached to the battery unit interface by an attractive force between the at least one magnet in the atomizing unit interface and at least one magnet in the battery unit interface; and
first recesses or pillars, and one of the at least one magnets is embedded in each of the first recesses or pillars, the first recesses or pillars dimensioned and positioned to receive complementary pillars or be received by complementary recesses on the battery unit interface when the atomizing unit interface is coupled to the battery unit interface;
wherein the atomizing unit and the battery unit form an electronic atomization system when assembled.

9. The atomizing unit interface of claim 8, wherein the first recesses or pillars are regular polygonal.

10. The atomizing unit interface of claim 8, wherein the atomizing unit interface has a plurality of second recesses or protrusions dimensioned and positioned to receive complementary protrusions or be received by complementary recesses in the battery unit interface when the atomizing unit interface is coupled to the battery unit interface to prevent rotation of the atomizing unit interface in relation to the battery unit interface while coupled.

11. The atomizing unit interface of claim 10, wherein the plurality of second recesses or protrusions are provided along the periphery of the atomizing unit interface.

12. A battery unit interface coupling a battery unit with an atomizing unit interface of an atomizing unit, the battery unit interface comprising:
at least one magnet for the battery unit interface to be releasably attached to the atomizing unit interface by an attractive force between the at least one magnet in the battery unit interface and at least one magnet in the atomizing unit interface; and
first recesses or pillars, and one of the at least one magnets is embedded in each of the first recesses or pillars, the first recesses or pillars dimensioned and positioned to receive complementary pillars or be received by complementary recesses on the atomizing unit interface when the atomizing unit interface is coupled to the battery unit interface;
wherein the atomizing unit and the battery unit form an electronic atomization system when assembled.

13. The battery unit interface of claim 12, wherein the first recesses or pillars are regular polygonal.

14. The battery unit interface of claim 12, wherein the battery unit interface has a plurality of second recesses or protrusions dimensioned and positioned to receive complementary protrusions or be received by complementary recesses in the atomizing unit interface when the battery unit interface is coupled to the atomizing unit interface to prevent rotation of the atomizing unit interface in relation to the battery unit interface while coupled.

15. The battery unit interface of claim 14, wherein the plurality of second recesses or protrusions are provided along the periphery of a surface of the battery unit interface that abuts the atomizing unit interface when the battery unit interface is coupled to the atomizing unit interface.
